(19) United States
(12) Patent Application Publication
(10) Pub. No.: US 2014/0274174 A1
(43) Pub. Date: Sep. 18, 2014

(54) APPARATUS AND METHOD FOR WIRELESS COMMUNICATION, HAVING FUNCTIONS OF DIFFERENT COMMUNICATION SYSTEMS

(71) Applicant: Kabushiki Kaisha Toshiba, Minato-ku (JP)

(72) Inventors: Masahiro Sekiya, Inagi-shi (JP); Koji Horisaki, Yokohama-shi (JP)

(73) Assignee: KABUSHIKI KAISHA TOSHIBA, Minato-ku (JP)

(21) Appl. No.: 13/962,195

(22) Filed: Aug. 8, 2013

(30) Foreign Application Priority Data
Mar. 13, 2013 (JP) 2013-050918

(51) Int. Cl. H04W 88/06

(52) U.S. Cl. CPC H04W 88/06
USPC 455/500

(57) ABSTRACT

According to one embodiment, a wireless communication apparatus includes a first wireless communication unit, a second wireless communication unit, a reception power management unit, a frequency selection unit, and a frequency-hopping management unit. The second wireless communication unit performs wireless communication by means of a second wireless communication system different from the first communication system. The reception power management unit measures reception power. The frequency selection unit selects frequency-channel data enabling the second wireless communication unit to perform communication, on the basis of the reception power measured by the reception power management unit. The frequency-hopping management unit determines a frequency channel from the frequency-channel data selected by the frequency selection unit, if the second wireless communication unit performs communication by using a frequency hopping system.

### CROSS-REFERENCE TO RELATED APPLICATIONS

This application is based upon and claims the benefit of priority from Japanese Patent Application No. 2013-050918, filed Mar. 13, 2013, the entire contents of which are incorporated herein by reference.

### FIELD

Embodiments described herein relate generally to a wireless communication apparatus having the wireless communication functions of different communication systems.

### BACKGROUND

In recent years, apparatuses having a wireless communication function have been widely used in the form of electronic apparatuses such as notebook computers, game consoles, car navigation units, digital cameras, and mobile data terminals. Known as wireless communication systems for these communication apparatuses are, for example, IEEE 802.11-compatible wireless LAN and Bluetooth (trademark).

Recently, both the Bluetooth function and the wireless LAN function are often implemented in the notebook computer, a mobile data terminal or a large scale integrated circuit (LSI). This may impair, in some cases, the performance of the Bluetooth communication.

### BRIEF DESCRIPTION OF THE DRAWINGS

FIG. 1 is a diagram snowing a wireless communication system to which a first embodiment is applied;

FIG. 2 is a diagram showing the configuration of a wireless communication apparatus according to the first embodiment;

FIG. 3 is a sequence chart explaining how the first embodiment operates;

FIG. 4 is a diagram showing an exemplary wireless-communication state;

FIG. 5 is a diagram showing an exemplary wireless-communication state observed;

FIG. 6 is a diagram showing the wireless communication system applied to a second embodiment;

FIG. 7A is a diagram showing a change in the power at which the subcarrier is received;

FIG. 7B is a diagram showing exemplary wireless-LAN signals received in a frequency channel;

FIG. 8 is a flowchart showing how the second embodiment operates;

FIG. 9A is a diagram showing a change in the power at which the subcarrier is received; and

FIG. 9B is a diagram showing an exemplary wireless-LAN signal received at a frequency channel.

### DETAILED DESCRIPTION

In general, according to one embodiment, a wireless communication apparatus includes a first wireless communication unit, a second wireless communication unit, a reception power management unit, a frequency selection unit, and a frequency-hopping management unit. The first wireless communication unit performs wireless communication by means of a first wireless communication system. The second wireless communication unit performs wireless communication by means of a second wireless communication system different from the first communication system. The reception power management unit measures reception power. The frequency selection unit selects frequency-channel data enabling the second wireless communication unit to perform communication, on the basis of the reception power measured by the reception power management unit. The frequency-hopping management unit determines a frequency channel from the frequency-channel data selected by the frequency selection unit, if the second wireless communication unit performs communication by using a frequency hopping system.

Bluetooth uses a frequency band of 2.4 GHz. There may be communication apparatuses of different communication systems that utilize the same frequency band. In this environment, some apparatuses may perform communication at the same time. If this is the case, one communication will probably cause wave interference with any other communication, inevitably decreasing the performance of the other communication.

A method of reducing the decrease in the communication performance is known. In the method, the Bluetooth apparatus measures the packet error rates in the channels used, and any channel in which the error rate is greater than or equal to a threshold value is excluded from the frequency channels subjected to frequency hopping.

Another method of reducing the decrease in the communication performance is known. In this method, a wireless LAN apparatus is used, acquiring the data representing the power at which any wireless LAN access point around the LAN apparatus transmits a wireless signal, and any frequency band at which access points are congested is excluded from those subjected to the frequency hopping of Bluetooth communication.

The wireless LAN communication utilizing the 2.4-GHz band, such as 802.11b/g/n, occupies a broader communication-frequency band than the Bluetooth does. On the Bluetooth side, it may therefore take much time to exclude the frequency band in which the wireless LAN performs communication.

Further, the method in which the wireless LAN apparatus only acquires the reception power from any wireless LAN access point around it cannot determine whether the frequency band of the wireless LAN signal is narrow or not.

In this embodiment, a Bluetooth apparatus and a wireless LAN apparatus are incorporated in the same apparatus, and the wireless LAN apparatus scans frequency channels, acquiring data about any frequency channel that will probably impair the Bluetooth communication and ultimately decrease Bluetooth communication performance.

Various embodiments will be described with reference to the accompanying drawings.

### First Embodiment

FIG. 1 is a diagram snowing a wireless communication system to which a first embodiment is applied.

As shown in FIG. 1, wireless base stations 100, 110, 120 and 130, each having an IEEE 802.11-compatible wireless LAN function (such as IEEE 802.11b, IEEE 802.11g or IEEE 802.11n), and wireless terminals 101, 111, 121 and 131 constitute wireless LAN communication systems 1, 2, 3 and 4.

On the other hand, a wireless terminal 150 and a wireless terminal 151 constitute a Bluetooth communication system 1, and a wireless terminal 160 and a wireless terminal 161 constitute a Bluetooth communication system 2. The wireless terminals 150, 160 and 161 have the Bluetooth function (i.e., BLT in FIG. 1). The wireless terminal 151 has the Bluetooth function and the wireless LAN function (i.e., WLAN in FIG. 1).

### (Function of Each Wireless Apparatus)

The wireless base stations 100, 110, 120 and 130 and the wireless terminals 101, 111, 121 and 131 can perform communication by using the wireless LAN communication systems, but cannot perform Bluetooth communication.

The wireless terminals 150, 160 and 161 can perform Bluetooth communication, but cannot achieve wireless communication of any other wireless system.

The wireless terminal 151 can perform Bluetooth communication and can also receive and transmit wireless LAN frames.

The wireless terminal 151 may incorporate the IEEE 802.11-compatible wireless LAN function and the Bluetooth wireless communication function in the form of independent wireless communication modules. Alternatively, the wireless terminal 151 may incorporate an LSI having both the IEEE 802.11-compatible wireless LAN function and the Bluetooth wireless communication function.

### (Exemplary Configuration of the Wireless Communication Apparatus)

FIG. 2 is a diagram showing the configuration of a wireless communication apparatus 200 according to the first embodiment. The wireless communication apparatus 200 is applied to, for example, the wireless terminal 151.

The wireless communication apparatus 200 is configured for both the Bluetooth communication system and the wireless LAN communication system. The apparatus 200 therefore has a wireless LAN communication unit 210 and a Bluetooth wireless communication unit 220.

The wireless LAN communication unit 210, for example, has a wireless communication function based on IEEE 802.11 (including IEEE 802.11b, IEEE 802.11g and IEEE 802.11n functions). On the other hand, the Bluetooth wireless communication unit 220 has a wireless communication function based on the Bluetooth standard (including Bluetooth Versions 2.1 and 3.0, Enhanced Data Rate [EDR], High Speed [HS], Low Energy [LE], etc.).

Antennas 210a and 220a are connected to the wireless LAN communication unit 210 and the Bluetooth wireless communication unit 220, respectively. Instead, one antenna may be used for both the wireless LAN communication unit 210 and the Bluetooth wireless communication unit 220.

Further, the wireless communication apparatus 200 may incorporate the wireless LAN function and the Bluetooth wireless function in the form of independent wireless communication modules. Alternatively, the apparatus 200 may incorporate an LSI that performs both the wireless LAN function and the Bluetooth wireless function.

The wireless communication apparatus 200 further comprises a reception power management unit 213 and a frequency selection unit 230. The reception power management unit 213 is configured to measure and manage the reception power for wireless frequency channels. The frequency selection unit 230 is configured to generate frequency channel data that the Bluetooth wireless communication unit 220 may use to perform Bluetooth communication.

The wireless LAN communication unit 210 is constituted by a physical layer section 211 and a medium access control (MAC) layer section 212. As shown in FIG. 2, the reception power management unit 213 is provided in, for example, physical layer section 211, but is not limited to this in terms of location.

The physical layer section 211 performs specific modulation and encoding based on the IEEE 802.11 standard, performs data transmission and reception process including demodulation and decoding such as fast Fourier transform (FFT), and transmit and receives wireless signals. As described in the physical layer regulations of the IEEE 802.11 standard, either spectrum diffusion of the direct sequence system or OFDM system is utilized. In the frequency band of 2400 to 2483.4 MHz, 13 frequency channels are allocated, at intervals of 5 MHz. A desirable channel may be selected from these 13 frequency channels. In the frequency channel selected, a transmission band of about 20 MHz may be used in 802.11b, 802.11g or 802.11n, and a transmission band of about 40 MHz may be used in 802.11n, in some cases.

The MAC layer section 212 performs a specific IEEE 802.11-based access control. The IEEE 802.11-based access control achieves a carrier-sense multiple access with collision avoidance (CSMA/CA) that first observes the use state of the wireless environment and then determines whether frames should be transmitted or not.

The MAC layer section 212 also add a MAC header to the data to transmit, and transmits an acknowledgement (ACK) frame on receiving a data frame that is one type of an 802.11-MAC frame. The transmission is controlled, particularly by a transmission control unit 214.

Like the wireless communication apparatus 200, the Bluetooth wireless communication unit 220 has a physical layer section 221 and a MAC layer section 222.

The physical layer section 221 performs specific modulation and encoding based on the Bluetooth standard, performs data transmission and reception process including demodulation and decoding based on the Bluetooth standard, and transmit and receives wireless signals.

The MAC layer section 222 performs a specific access control based on the Bluetooth standard.

The Bluetooth standard specifies a wireless communication performed by using the frequency hopping system. The wireless communication performed by means of the frequency hopping system defines 79 frequency channels at intervals of 1 MHz, in the frequency band of 2400 to 2483.5 MHz. These frequency channels are switched, one to another, in time-division based on a particular hopping pattern, each time for one time slot (=625 μs). Thus, each frequency channel is occupied for one time slot.

The Bluetooth standard also specifies a wireless communication performed by using the master-slave system in which the master manages the hopping pattern. Using the same hopping pattern, one master and seven slaves, at most, constitute a wireless network called a piconet, and perform mutual communication.

Each processing unit provided in the wireless communication apparatus 200 may be implemented as an analog or digital circuit. Alternatively, it may be implemented by software executed by a central processing unit (CPU).

### (Operation)

With reference to FIG. 3 to FIG. 5, it will be explained how the wireless base stations 100, 110, 120 and 130 and wireless terminals 101, 111, 121 and 131 perform communication, by using the wireless LAN, and how the wireless terminals 150 and 160 and wireless terminal 151 and 161 perform communication, by using Bluetooth.

### (Prediction of the Wireless Communication)

The Bluetooth wireless communication unit 220 gives instructions to the wireless LAN communication unit 210, to detect the state of the wireless frequency channels (S11).

In the wireless LAN communication unit 210, the MAC layer section 212 scans the state of the wireless LAN communication (S12).

FIG. 4 shows an exemplary canning result observed in the communication environment of FIG. 1. The MAC layer section 212 detects wireless LAN communications 1 to 3 in which the reception power is large in channels Ch. 1, Ch. 6 and Ch. 11 as shown in FIG. 4. In channel Ch. 11, wireless LAN communication 4 is also detected, in which the reception power is less than in the wireless LAN communication 3.

Next, the reception power management unit 213 detects a frequency band. More precisely, the reception power management unit 213 receives a wireless signal, performs an FFT process on the wireless signal, and detects the reception power. The reception power management unit 213 thus determines whether the band of each frequency channel is one used by the wireless LAN signal and narrower than the wireless LAN signal band (S13).

As a result, it is assumed that the longest time the narrowband signal occupies at any frequency ranging from 2427 to 2447 MHz has been detected, and that the next longest time the narrowband signal occupies at any frequency ranging from 2402 to 2422 MHz has been detected.

FIG. 5 shows the result of the scanning described above. As seen from FIG. 5, in wireless LAN communications 1, 2, 3 and 4 on frequency channels 1, 6 and 11, the signals in frequency channels 1 and 6 are narrowband signals occupying time T2 shorter than time T1 for wireless LAN communication, and the signal in frequency channel 11 is a wideband signal.

The data representing the scanning result described above is supplied to the frequency selection unit 230.

### (Section of the Frequency Channel)

From the data representing the scanning result and supplied from the wireless LAN communication unit 210, the frequency selection unit 230 determines that frequency channel Ch. 11 in which the wireless LAN communications 3 and 4 are performed should be excluded (S14).

That is, narrowband signals received at power Rx2 and occupying time T2 as shown in FIG. 5 are detected in frequency channels Ch. 1 and Ch. 6. By contrast, wideband signals of the wireless LAN communications 3 and 4 are detected in frequency channel Ch. 11. Hence, frequency channel Ch. 11 is determined to be a frequency channel not so reliable to ensure communication quality for the Bluetooth wireless communication unit 220. (For example, the channel Ch. 11 may cause many CRC errors when it receives Bluetooth packets.) Frequency channel Ch. 11 will therefore be excluded. The frequency selection unit 230 notifies frequency channel Ch. 11, which should be excluded, to the Bluetooth wireless communication unit 220.

The Bluetooth wireless communication unit 220 incorporates a frequency-hopping management unit 223. The frequency-hopping management unit 223 controls the frequency hopping in accordance with the frequency channel notified from the frequency selection unit 230 (S15). In the case specified above, the frequency-hopping management unit 223 excludes frequency channel Ch. 11, thus hopping the frequency, in controlling the frequency hopping.

### (Advantages)

In the conventional wireless communication apparatus, only the reception power and the time occupied thereby are measured, and the bandwidth is not measured at all. Consequently, any narrowband signal is a candidate to exclude from the frequency channel now used in the Bluetooth communication, if the signal is found to occupy the frequency band being observed.

In the first embodiment, however, the MAC layer section 212 of the wireless LAN communication unit 210 scans the state of wireless LAN communication, and the reception power management unit 213 determines whether the signal being transmitted in the communication is a narrowband signal or not. The frequency selection unit 230 can therefore select a frequency channel appropriate for the Bluetooth communication, on the basis of the state of wireless LAN communication scanned by the wireless LAN communication unit 210. Hence, the Bluetooth wireless communication unit 220 can determine a frequency channel appropriate for the Bluetooth communication, from the selection made by the frequency selection unit 230. The Bluetooth wireless communication unit 220 can therefore prevent the Bluetooth communication from being impaired in terms of performance.

### Second Embodiment

FIG. 6, FIG. 7A, FIG. 7B, FIG. 8, FIG. 9A and FIG. 9B show a second embodiment. In FIG. 6, the components identical to those of the first embodiment are designated by the same reference numbers.

As shown in FIG. 6, the transmission control unit 214 includes a measuring unit 213a, a plurality of counters CntT(c)fs 1 to CntT(c)fs 20. (Note that “(c)” indicates the frequency channel number ranging, for example, from 1 to 13.) The measuring unit 213a measures the reception powers of the sub-carriers fs1 to fs20 for each of frequency channels 1 to 13. Counters CntT(c)fs 1 to CntT(c)fs 20 are incremented every time the reception powers of the sub-carriers fs1 to fs20 exceed a prescribed threshold power Pth1. Namely, counters CntT(c)fs1 to CntT(c)fs20 are provided for the frequency channels, respectively. Hereinafter, counters CntT(c)fs1 to CntT(c)fs20 will be called “counters CntT1fs1 to CntT1fs20 if frequency channel 1 (Ch. 1), for example, has been selected, and called “counter CntT6fs1 to ContT6fs20 if the if frequency channel 1 (Ch. 6), for example, has been selected.

Counters CntT(c)fs1 to CntT1(c)fs20 need not be provided for each frequency channel. Rather, one set of counters CntT1fs1 to CntT1fs20 may be used. In this case, counters CntT1fs 1 to CntT1fs 20 are switched, from one to another, for each frequency.

More specifically, for frequency channel Ch. 1, for example, counters CntT1fs1 to CntT1fs20 operate as counters CntCnT(1)fs1 to CntT(1)fs20, and the count values these counters have upon lapse of a preset time are stored in, for example, a memory.

The, the frequency channel may be changed from Ch. 1 to Ch. 2. In this case, counters CntT(c)fs1 to CntT(c)fs20 operate as counters CntCnT(2)fs1 to CntT(2)fs20, and the count values these counters have upon lapse of the preset time are stored in the memory. Thereafter, counters CntT(c)fs1 to CntT(c)fs20 operate are switched for any other frequency channel and then operated in the same way as described above.

Further, counters CntT(c)fs1 to CntT(c)fs20 are variable in step-up width. The step-up width of each counter can be changed to a value ranging, for example, from “1” to “5.”

How the wireless communication apparatus 200 so configured as shown in FIG. 6 operates will be explained with reference to FIG. 7A, FIG. 7B and FIG. 8.

FIG. 7B is a diagram showing signals WLAN1 and WLAN4 received in frequency channel 1 (Ch.1) through the wireless LAN, in terms of frequency and duration (in time axis). FIG. 7A is a diagram showing how these signals WLAN1 and WLAN4 changes in reception power, as the sub-carrier (fs1) changes with time in frequency channel 1. In FIG. 7B, the vertical axis represents the bandwidth the wireless signals occupy, and the horizontal axis represents the time the wireless signals occupy.

In the reception power management unit 213 shown in FIG. 6, the reception power in the frequency channel selected is measured by a received signal strength indicator (RSSI, not shown). Then, it is determined whether the reception power measured is greater than the first threshold value or not (S31). If the reception power is less than the first threshold value, the process will be terminated. If the reception power is greater than the first threshold value, the FFT process will be performed on the wireless signals, and the received signal of each subcarrier will be output (S32). If the wireless LAN communication unit 210, for example, is waiting for wireless signals in a 20-MHz bandwidth, the physical layer section 211 performs the FFT process to change the bandwidth of the sub-carrier to 1 MHz.

As a result, signals are received on each sub-carrier, and the reception power of the signals is output for the sub-carrier. FIG. 7A shows how the sub-reception power of the sub-carrier (fs1) changes with time.

The measuring unit 213a of the reception power management unit 213 determines, for each sub-carrier, whether the reception power is greater than or equal to the threshold power Pth1 shown in FIG. 7A (S33). If the reception power is less than the threshold power Pth1, the control goes to Step S31.

On the other hand, the reception power may be greater than or equal to the threshold power Pth1. In this case, it is determined whether the number Nsub of sub-carriers existing simultaneously at the threshold power Pth1 or any greater power exceeds 15 or not (S34). If the number Nsub is less than or equal to 15, those of the counters (CntT1fs1 to CntT1fs20) which are associated with the sub-carriers will be incremented (S35).

If the number Nsub of sub-carriers existing simultaneously at the threshold power Pth1 or any greater power is greater than 15, those of counters CntT1fs1 to CntT1fs20, which are associated with the sub-carriers are incremented by the second step-up width (for example, “5”) greater than the first step-up width (S36).

To be more specific, the number Nsub of sub-carriers is greater than 15 in the period from time t0 to time t1, because the reception powers at the sub-carriers fs1 to fs20 are greater than or equal to Pth1 in that period. Counters CntT1fs1 to CntT1fs20 are therefore incremented by the second step-up width.

The reception powers at all sub-carriers fs1 to fs20 are less than the threshold power Pth1 at time t2. Hence, at time t2, counters CntT1fs1 to CntT1fs20 are not incremented at all.

In the period from time t3 to time t4, the reception powers at the sub-carriers fs1 to fs20 are greater than or equal to Pth1 as in the period from time t0 to time t1. The number Nsub of sub-carriers is therefore greater than 15. Hence, counters CntT1fs1 to CntT1fs20 are incremented by the second step-up width in the period from time t3 to time t4.

Thus, counters CntT1fs1 to CntT1fs20 hold the count values for the respective sub-carriers.

FIGS. 9A and 9B show a signal received in another frequency channel, for example, frequency channel 6 (Ch. 6). In the case shown of FIGS. 9A and 9B, counters CntT1fs1 to CntT1fs20 hold the count values for the respective sub-carriers of frequency channel 6.

If the power changes as shown in FIG. 9B, a signal WLAN2 occupying the period from time t0 to t1 may be observed like the wireless signal WLAN1 shown in FIG. 7B. In this case, the counters have the same count values for the respective sub-carriers, as explained above. That is, since the reception powers at all sub-carriers fs1 to fs20 are greater than or equal to the threshold power Pth1 in the period from time t0 to time t1, the number Nsub of sub-carriers is greater than 15. Counters CntT1fs1 to CntT1fs20 are therefore incremented by the second step-up width (for example, “5”) in the period from time t0 to time t1.

On the other hand, in FIGS. 9A and 9B, the reception powers at the sub-carrier 1 (fs1) only is greater than or equal to the threshold power Pth1 in the period from time t3 to time t4. Only counter CntT6fs1 associated with the sub-carrier 1 is therefore incremented by the first step-up width (for example, “1”).

As seen from FIGS. 9A and 9B, the reception powers at all sub-carriers fs1 to fs20 are less than the threshold power Pth1 in the period from time t4 to time t6. Therefore, counters CntT1fs1 to CntT1fs20 are not incremented in this period.

Since the count vales of counters CntT1fs1 to CntT1fs20 change as specified above, the count values CntT1fs1 and CntT6fs1 observed in frequency channels 1 and 6, respectively, have the relation of CntT1fs1>CntT6fs1.

Further, the sum of the count values of counters CntT1fs1 to CntT1fs20 is greater than the sum of the count values of counters CntT6fs1 to CntT6fs20.

Hence, the transmission control unit 214 determines that frequency channel 1 is a channel more susceptible to interference than frequency channel 6 in the Bluetooth communication.

The transmission control unit 214 then instructs the frequency selection unit 230 to exclude the band of frequency channel 1 in the Bluetooth communication. The frequency selection unit 230 accordingly excludes frequency channel 1, causing the frequency-hopping management unit 223 to perform the Bluetooth communication.

According to the second embodiment, the reception power management unit 213 has counters CntT(c)fs1 to CntT(c)fs20 for the respective frequency channels of the wireless LAN communication. These counters CntT(c)fs1 to CntT(c)fs20 have their count values incremented if the reception powers at the sub-carriers fs1 to fs20 are greater than the threshold power Pth1. Thus, the counters hold count values for the respective frequency channels and the respective sub-carriers. The transmission control unit 214 determines a frequency channel in which the Bluetooth communication may receive interference from the wireless LAN communication, and notifies this frequency channel to the frequency selection unit 230. The frequency-hopping management unit 223 can therefore exclude any channel susceptible to interference, and can determine a frequency appropriate for the Bluetooth communication. Hence, the second embodiment can enhance the quality of the Bluetooth communication.

Moreover, counters CntT(c)fs1 to CntT(c)fs20 are incremented by the step-up width “5” if the number of sub-carriers at reception powers exceeding the threshold value Pt1 is greater than 15, and by the step-up width “1” if the number of sub-carriers at such reception powers is less than or equal to 15. This helps to clarify a difference between the reception powers. Hence, it is easy to determine, from the count values, channels in which the Bluetooth communication is susceptible to interference from the wireless LAN communication.

Two or more largest values may exist in the count values of the counters. In this case, the frequency selection unit 230 may exclude the frequency channel for which the sub-carriers have been counted by the second step-up width for the longer time.

### Third Embodiment

In the second embodiment described above, the sub-carriers associated with two specific frequency channels, that have exceeded the threshold power Pth1, are counted, and the Bluetooth communication is controlled in accordance the number of the sub-carriers.

In the third embodiment, counters CntT(c)fs(k) (k is the sub-carrier number ranging, for example, from 1 to 20) calculate the sum of count values, and the data to transmit through Bluetooth communication is transmitted by means of the wireless LAN communication if the sum of count values is greater than or equal to a prescribed threshold value.

Alternatively, if the count values of counters CntT(c)fs(k) are each greater than or equal to a prescribed threshold value, the data to transmit through Bluetooth communication may be transmitted by means of the wireless LAN communication.

In the third embodiment, if the Bluetooth communication is obviously interfered with the wireless LAN communication, it will not be used, and the wireless LAN communication is used instead. Hence, the Bluetooth communication can be prevented from being impaired in quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first wireless communication unit configured to perform wireless communication by means of a first wireless communication system;
a second wireless communication unit configured to perform wireless communication by means of a second wireless communication system different from the first communication system;
a reception power management unit configured to measure reception power;
a frequency selection unit configured to select frequency-channel data enabling the second wireless communication unit to perform communication, on the basis of the reception power measured by the reception power management unit; and
a frequency-hopping management unit configured to determine a frequency channel from the frequency-channel data selected by the frequency selection unit, if the second wireless communication unit performs communication by using a frequency hopping system.

2. The apparatus according to claim 1, wherein the reception power management unit comprises:
a measuring unit configured to measure reception powers for respective sub-carriers of a frequency band lower than the frequency band used in the first wireless communication system, in a plurality of frequency channels included in a reception frequency band; and
a plurality of counters associated with the sub-carriers, respectively, each configured to be incremented if the reception power of the associated sub-carrier exceeds a first threshold value.

3. The apparatus according to claim 2, wherein if the number of sub-carriers having reception powers exceeding the first threshold value is less than or equal to a prescribed number, the counters associated with these sub-carriers are incremented by a first step-up width; and if the number of sub-carriers having reception powers exceeding the first threshold value is greater than the prescribed number, the counters associated with these sub-carriers are incremented by a second step-up width greater than the first step-up width.

4. The apparatus according to claim 3, wherein the frequency selection unit selects, as frequency channel to exclude, the frequency channel having the largest of the count values measured for the frequency channels.

5. The apparatus according to claim 4, wherein the frequency-hopping management unit does not utilize the frequency channel excluded, in the wireless communication performed by means of the second wireless communication system.

6. The apparatus according to claim 3, wherein if at least two frequency channels have the largest count values, the frequency selection unit selects, as frequency channel to exclude, the frequency channel counted for a longer time with the second step-up width.

7. The apparatus according to claim 6, wherein if the count values of the counters, measured in the frequency channels, are all greater than or equal to a first count value, data to transmit by means of the second communication system is transmitted by means of the first communication system.

8. The apparatus according to claim 6, wherein the first communication system is a wireless LAN.

9. The apparatus according to claim 6, wherein the second communication system is Bluetooth.

10. A wireless communication method for performing wireless communication by means of a first wireless communication system and wireless communication by means of a second wireless communication system different from the first wireless communication system, the method comprising:
measuring reception power;
selecting frequency-channel data enabling the second wireless communication unit to perform communication, on the basis of the reception power measured; and
determining a frequency channel from the frequency-channel data selected, if the second wireless communication system performs the communication by using a frequency hopping system.

11. The method apparatus according to claim 10, wherein the measuring reception power comprises:
measuring reception powers for respective sub-carriers of a frequency band lower than the frequency band used in the first wireless communication system, in a plurality of frequency channels included in a reception frequency band; and
incrementing a plurality of counters associated with the sub-carriers, respectively, if reception powers of the associated sub-carriers exceed a first threshold value.

12. The method apparatus according to claim 11, wherein if the number of sub-carriers having reception powers exceeding the first threshold value is less than or equal to a prescribed number, the counters associated with these sub-carriers are incremented by a first step-up width; and if the number of sub-carriers having reception powers exceeding the first threshold value is greater than the prescribed number, the counters associated with these sub-carriers are incremented by a second step-up width greater than the first step-up width.

13. The method apparatus according to claim 12, wherein the frequency channel having the largest of the count values measured for the frequency channels is selected as frequency channel to exclude.

14. The method apparatus according to claim 13, wherein if the communication is performed by using a frequency hopping system, the frequency channel excluded is not used in the wireless communication performed by means of the second wireless communication system.

15. The method according to claim 12, wherein if at least two frequency channels have the largest count values, the frequency channel counted for a longer time with the second step-up width is excluded.

16. The method according to claim 15, wherein if the count values of the counters, measured in the frequency channels, are all greater than or equal to a first count value, data to transmit by means of the second communication system is transmitted by means of the first communication system.

17. The method according to claim 15, wherein the first communication system is a wireless LAN.

18. The method according to claim 15, wherein the second communication system is Bluetooth.
